(19) United States
(12) Patent Application Publication
(10) Pub. No.: US 2011/0140684 A1
(43) Pub. Date: Jun. 16, 2011

(54) POWER CONTROLLER HAVING EXTERNALLY ADJUSTABLE DUTY CYCLE

(75) Inventor: Ben-Sheng CHEN, Wugu Township (TW)

(73) Assignee: Chiccony Power Technology Co., Ltd., Wugu Township (TW)

(21) Appl. No.: 12/634,688

(22) Filed: Dec. 10, 2009

(51) Int. Cl. H02J 4/00

(52) U.S. Cl. 323/351

(57) ABSTRACT

A power controller having externally adjustable duty cycle provides an inversely proportional relationship between duty cycle and input voltage and creates a conversion curve associated with the duty cycle and the input voltage. The slope and/or maximal duty cycle of the conversion curve can be dynamically adjusted through an external setting interface according to the specification of the magnetic components adopted in a power conversion circuit. Therefore, saturation of magnetic components is effectively prevented, and magnetic components with optimal specification are easily available to choose.

### BACKGROUND OF THE INVENTION

1. Field of the Invention

The present invention is related to a power controller, and more particularly to a power controller that externally and dynamically adjusts duty cycle thereof.

2. Description of the Related Art

Conventional power conversion circuits by and large comprise a controller, a magnetic component, a switch and the like. With reference to FIG. 8, a DC to DC boost conversion circuit has a PWM controller (70), a switching transistor (71) and an inductor (72). The PWM controller (70) is driven by means of pulse width modulation. The duty cycle of the switching transistor (71) is controlled by the controller (70). The inductor (72) is connected between an input terminal (Vin) and an output terminal (Vout). To prevent the inductance of the inductor (72) in the circuit from being saturated, the controller (70) adopts a current-limit mode to limit the current flowing through the inductor (72). As the current flowing through the inductor (72) is limited, no more inductance saturation of the inductor (72) is caused as a result of excessive current flowing through the inductor (72). However, because of inaccurate current measurement and time difference intrinsic to feedback current, the controller (70) fails to accurately control maximal current flowing through the inductor (72). Consequently, likelihood of transient saturation of the inductor (72) is still present.

To tackle the foregoing problem, a controller of other power conversion circuit is available to limit the value of the maximal current flowing through the magnetic component with a duty limiter adopting a constant duty cycle. When a high voltage is inputted to the power conversion circuit, the duty cycle is diminished if the controller is relatively slow in processing. The resulting current flowing through the magnetic component becomes enormously large and further gets the magnetic component saturated. Therefore, it seems that the issue can be solved as long as a smaller and safer value of the maximal current can be set up by the duty limiter. Whereas, such measure presents a negative impact when a low voltage is inputted to the power conversion circuit. Since the duty limiter adopts smaller maximal current to limit the current flowing through the magnetic component, an available operating range is narrower once the power conversion circuit is applied to a condition with low voltage input. Accordingly, using constant maximal current to limit duty cycle introduces different problems to the conditions of high and low input voltages.

To solve a dilemma like this, there is another technique associating a limited value of duty cycle and an input voltage with an inversely proportional relationship. Hence, when the power conversion circuit is applied to a condition with low voltage input, a relatively large operating range can still be secured and a magnetic component with smaller size can be selected. However, as far as the selection of magnetic component is concerned, miniaturization does not represent optimization. Although facilitating the selection of magnetic components with smaller size, the aforementioned approach fails to address an optimized circuit targeted at a maximal variation of magnetic flux density (Bmax) of a selected magnetic component and further minimize the size of the selected magnetic component. Therefore, feasible technical solutions for delivering a power conversion circuit optimized by selected magnetic components need to be further developed.

### SUMMARY OF THE INVENTION

An objective of the present invention is to provide a power controller having externally adjustable duty cycle, which externally and dynamically configures or adjusts duty cycle thereof. Power conversion circuits adopting the power controller are allowed to have smallest or optimal magnetic components so as to reduce size and cost thereof.

To achieve the foregoing objective, the power controller has an inverse proportional control module, a duty cycle control module, a PWM driving module, and an external setting interface.

The inverse proportion control module generates a maximal duty cycle inversely proportional to respective input voltage and creates a conversion curve associated with the maximal duty cycle and the input voltage so as to dynamically and selectively adjust at least one of a slope of the conversion curve and the maximal duty cycle.

The duty cycle control module controls the maximal duty cycle generated by the inverse proportional control module.

The PWM driving module generates a driving signal having a modulatable pulse width according to a limited maximum of duty cycle generated by the duty cycle control module.

The external setting interface is adapted for user to externally adjust the slope of the conversion curve and configure the maximal duty cycle.

Given the inverse proportional relationship between the input voltage and the duty cycle formulated by the power controller, the maximal variation of magnetic flux density of a magnetic component can be limited below a configured value. During a switching-on cycle of a power conversion circuit, the output voltage of the secondary windings of a transformer or the terminal voltage of the two terminals of an inductor represents an input voltage or a geometric mirrored voltage of the input voltage. Hence, the maximum of the variation of magnetic flux density also equals to the maximum of magnetic flux density. Consequently, the maximum of magnetic flux density is determined by the setting of the maximum of the duty cycle so that magnetic components do not get saturated and smallest magnetic components can be further selected.

### BRIEF DESCRIPTION OF THE DRAWINGS

FIG. 1 is a curve diagram of an operating principle adopted by the present invention;

FIG. 2 is a block diagram of a preferred embodiment of a power controller having externally adjustable duty cycle in accordance with the present invention;

FIG. 3 is a circuit diagram of a preferred embodiment of an external configuration interface in accordance with the present invention;

FIG. 4 is a curve diagram illustrating variation caused when the power controller of the present invention offsets duty cycle alone;

FIG. 5 is a curve diagram illustrating variation caused when the power controller of the present invention configures slope alone;

FIG. 6 is a curve diagram illustrating variation caused when the power controller of the present invention simultaneously offsets duty cycle and configures slope;

FIG. 7 is another curve diagram illustrating variation caused when the power controller of the present invention simultaneously offsets duty cycle and configures slope; and

FIG. 8 is a circuit diagram of a conventional DC to DC boost conversion circuit.

### DETAILED DESCRIPTION OF THE INVENTION

A power controller having externally adjustable duty cycle of the present invention can be adopted to various types of power conversion circuits, such as, buck, boost, buck/boost, flyback, forward and other types of DC to DC and AC to DC power conversion circuits.

The power controller of the present invention enables users to externally adjust slopes of inversely proportional conversion curves between input voltages and maximal duty cycles and/or configure maximal duty cycles thereof, thereby not only effectively preventing magnetic components in a power conversion circuit from being saturated but also more conveniently selecting magnetic components with smaller size. The principle of the power controller can be explained by the following equation associated with variation of magnetic flux density:

$$Δ B = \frac{V \times DT}{N \times Ae}$$

where

V represents an output voltage of a secondary windings of a transformer or a terminal voltage of two terminals of an inductor;

D represents a duty cycle of a switching component;

T represents a time duration between two successive duty cycles;

N represents a number of turns of the secondary windings of the transformer or a number of turns of a coil of the inductor; and

Ae represents an effective cross-sectional area of a magnetic component.

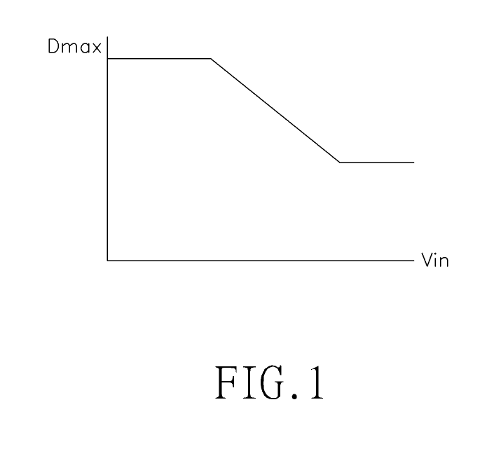

Normally, when magnetic components switch, a variation of magnetic flux density ΔB is proportional to DT, ΔB is also proportional to V. Hence, if intending to limit the maximum of ΔB, V must be inversely proportional to DT. With reference to FIG. 1, as T is usually a constant, V must be inversely proportional to D so as to limit the maximum of ΔB below a configured value. Furthermore, when the power conversion circuit is in a switching-on cycle, the output voltage of the secondary windings of the transformer or the terminal voltage of the two terminals of the inductor V represents an input voltage or a geometric mirrored voltage of the input voltage. Hence, the maximum of the variation of magnetic flux density ΔB also equals to the maximum of magnetic flux density (Bmax), meaning that the maximum of magnetic flux density (Bmax) is determined by the setting of the maximum of the duty cycle D.

Supported by the aforementioned principle, the power controller of the present invention provides external setting of the duty cycles and further externally adjusts slopes of conversion curves represented by ratios between the inversely proportional input voltages and the duty cycles. Given such adjustment, when building a power conversion circuit, magnetic components having optimal size and performance can be selected.

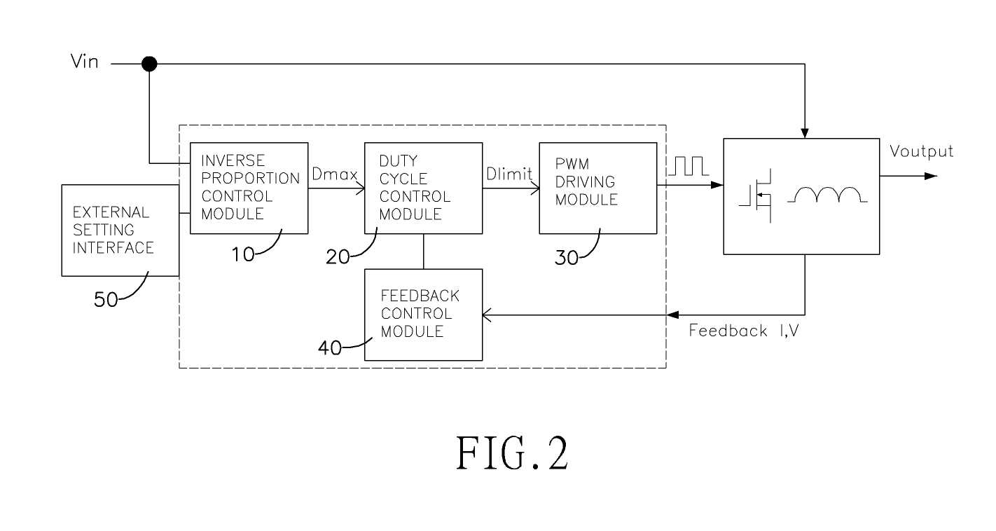

With reference to FIG. 2, a power controller of the present invention has an inverse proportion control module (10), a duty cycle control module (20), a PWM driving module (30), a feedback control module (40) and an external setting interface (50).

The inverse proportion control module (10) generates a maximal duty cycle (Dmax) inversely proportional to an input voltage (Vin) so as to generate a maximum of the variation of magnetic flux density ΔB, and creates a conversion curve associated with the input voltage and the duty cycle (with further reference to FIG. 1). The external setting interface (50) is adopted to externally adjust the slope of the conversion curve and the maximal duty cycle (Dmax) of the conversion curves.

The duty cycle control module (20) limits the maximal duty cycle (Dmax) generated by the inverse proportion control module (10) and generates a limited maximum of duty cycle (Dlimit), and transmits it to the PWM driving module (30) as a basis for the PWM driving module (30) to generate a driving signal. The limited maximum of duty cycle (Dlimit) can still be externally adjusted through the external setting interface (50).

The feedback control module (40) is adopted to receive a feedback signal (feedback voltage or current) and transmit it to the duty cycle control module (20) so as to adjust the limited maximum of duty cycle (Dlimit) transmitted to the PWM driving module (30).

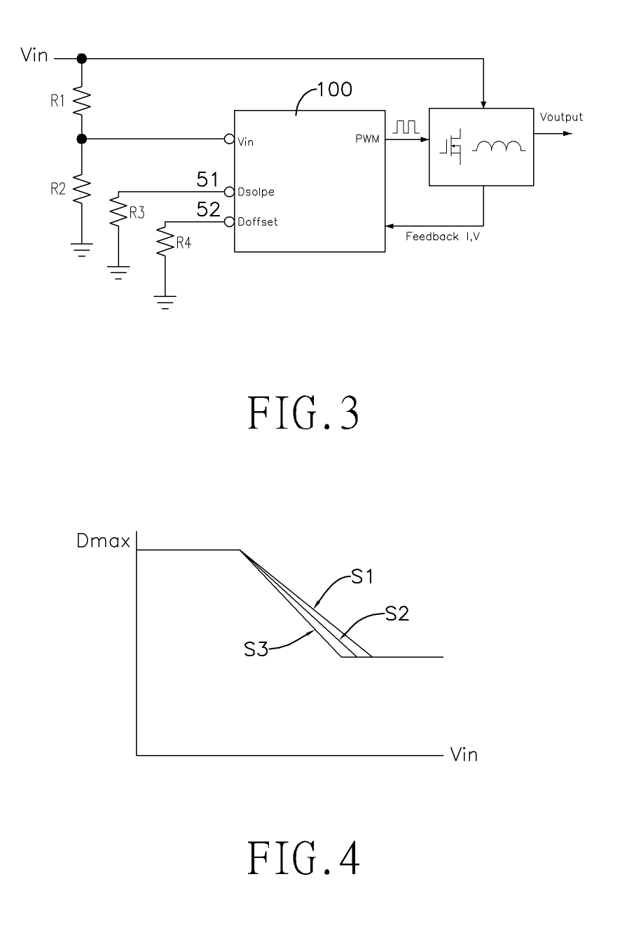

As mentioned earlier, the slope of the conversion curve created by the inverse proportion control module (10) and the maximal duty cycle can all be configured outside the power controller through the external setting interface (50). With reference to FIG. 3, one feasible approach is to provide more than one setup pin on the power controller (100) for adjusting the slope of the conversion curve and the maximum of the duty cycle. The present embodiment provides the power controller (100) with two pins (51)(52) connected with passive components for performing the adjustment. One pin (51) thereof serves as a slope setting pin (Dslope) for adjusting the slope of the conversion curve. The other pin (52) serves as an offset setting pin (Doffset) for configuring the maximal duty cycles.

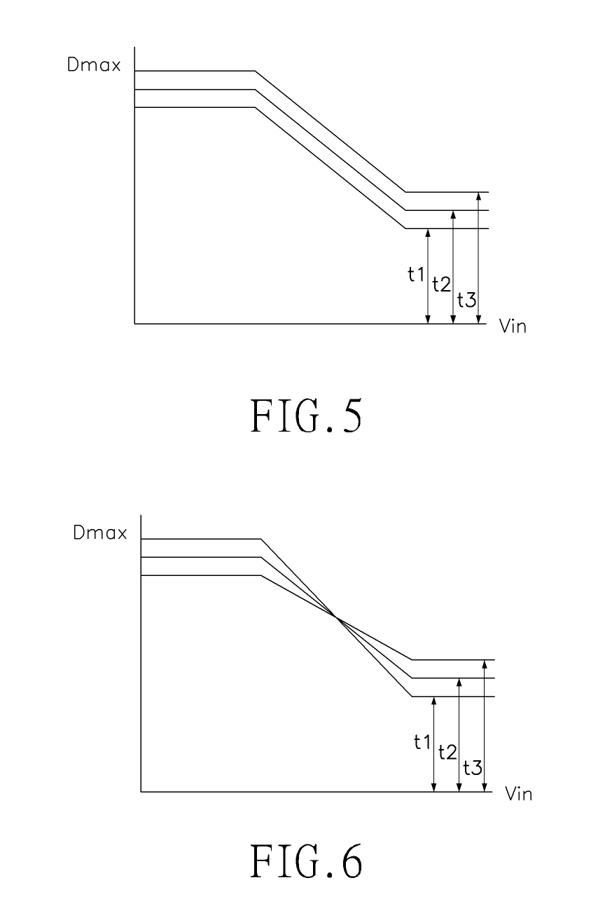

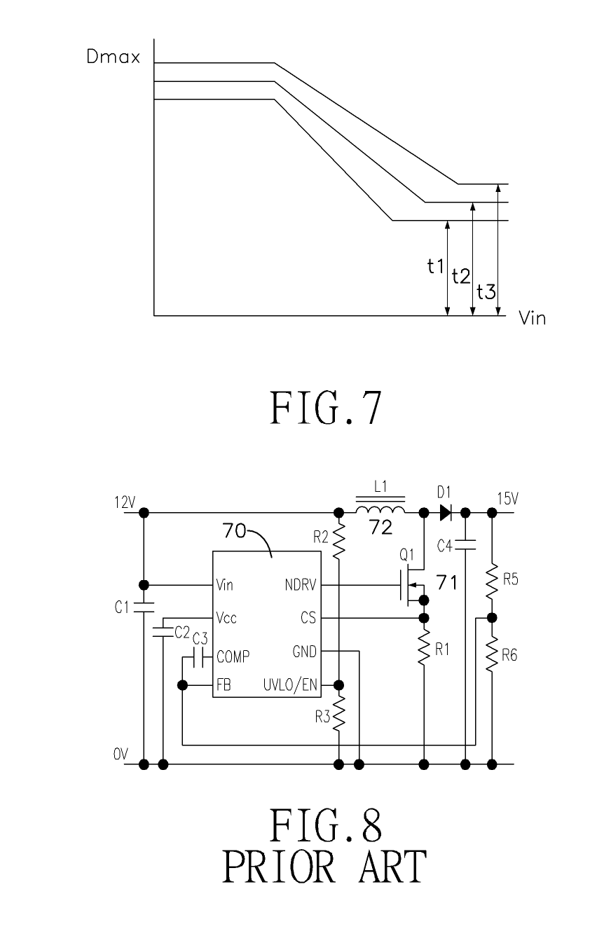

With reference to FIG. 4, the slopes of the conversion curves configured by the slope setting pin (Dslope) are S1, S2 and S3 respectively. With reference to FIG. 5, when the maximal duty cycles are configured by the offset setting pin (Doffset), different conversion curves with different offsets (t1, t2 and t3) are presented. With reference to FIGS. 6 and 7, different conversion curves are presented when the slopes and the maximal duty cycles are adjusted simultaneously.

In sum, based on the operating principle and the embodiment, the present invention at least has the following features and advantages:

a. Selection of optimal (minimal size of) magnetic component

The power controller of the present invention externally adjusts maximal duty cycles of a magnetic component based on maximal variation of magnetic flux density thereof, thereby conveniently selecting smallest magnetic components or optimized magnetic components to reduce size and cost.

b. Environmental immunity from saturation of magnetic components

As the maximal duty cycle can be configured to choose the maximal variation of magnetic flux density of magnetic components, magnetic components in a power conversion circuit do not saturate at any time due to an input voltage.

c. There is no concern about the issue that conventional current-limiting power controller fails to effectively limit the current flowing through magnetic components as a result of inaccurate current measurement and incorrect feedback timing.

d. Conventional power controller adopts the duty limiter with a fixed duty cycle to limit the maximal current flowing through magnetic components. When a power system is built with a hold-up time requirement, the fixed duty cycle must have a relatively large value during a low-voltage input. On the other hand, the inputted current may be excessively large during a high-voltage input. To settle the dilemma, the present invention associates the duty cycles and the input voltages with an inversely proportional relationship so that a bulk capacitor can still output energy during a low-voltage input. The selected bulk capacitor can be built with smaller size to effectively save cost.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A power controller having externally adjustable duty cycle, comprising:
an inverse proportion control module generating a maximal duty cycle inversely proportional to respective input voltage and creating a conversion curve associated with the maximal duty cycle and the input voltage so as to dynamically and selectively adjust at least one of a slope of the conversion curve and the maximal duty cycle;
a duty cycle control module controlling the maximal duty cycle generated by the inverse proportional control module;
a PWM driving module generating a driving signal having a modulatable pulse width according to a limited maximum of duty cycle generated by the duty cycle control module; and
an external setting interface adapted for user to externally adjust the slope of the conversion curve and configure the maximal duty cycle.

2. The power controller as claimed in claim 1, comprising more than one pins formed thereon as the external setting interface for adjusting the slope of the conversion curve and configuring the maximal duty cycle.

3. The power controller as claimed in claim 1, comprising two pins formed thereon as the external setting interface, one of the pins being a slope setting pin for adjusting the slope of the conversion curve, the other pin being an offset setting pin for configuring the maximal duty cycle.
